(19) United States
(12) Patent Application Publication
(10) Pub. No.: US 2026/0296134 A1
(43) Pub. Date: Oct. 1, 2026

(54) AIR CONDITIONER AND VEHICLE

(71) Applicant: GD MIDEA AIR-CONDITIONING EQUIPMENT CO., LTD., Foshan (CN)

(72) Inventor: Yinyin ZHANG, Foshan (CN)

(21) Appl. No.: 18/996,527

(22) PCT Filed: Oct. 24, 2022
(86) PCT No.: PCT/CN2022/127144

§ 371 Date: Jan. 17, 2025

(30) Foreign Application Priority Data
Aug. 31, 2022 (CN) 202211068345.1

(51) Int. Cl. B60H 1/00; B60H 1/32

(52) U.S. Cl. CPC B60H 1/00564; B60H 1/00514; B60H 1/3204

(57) ABSTRACT

An air conditioner includes a housing, indoor and outdoor air ducts in the housing, and first and second fans located in the indoor and outdoor air ducts, respectively. The housing includes an indoor air inlet and an indoor air outlet at a lower position of the housing and provided in a front-and-back offset, an outdoor air inlet at a side of the housing, and an outdoor air outlet. The indoor air duct is connected between the indoor air inlet and the indoor air outlet, extends in a front-and-back direction, and bends upward. The outdoor air duct is connected between the outdoor air inlet and the outdoor air outlet, and is spaced apart from the indoor air duct in the front-and-back direction.

### CROSS-REFERENCE TO RELATED APPLICATION

The present application claims priority to Chinese Patent Application No. 202211068345.1, filed on Aug. 31, 2022, the entire contents of which are incorporated herein by reference.

### TECHNICAL FIELD

The present application relates to the technical field of air conditioners, in particular to an air conditioner and a vehicle.

### BACKGROUND

Common vehicle parking air conditioners are generally aimed at vehicles, which have small indoor spaces. The fan system itself needs to occupy the main internal space, and the layout of the indoor and outdoor air ducts itself requires a certain amount of space, resulting in increased space requirements for the entire machine and greater air resistance. Due to the limitation of the thinness and miniaturization design requirements of the whole machine, the fan air duct system tends to compress the height space. This layout limits the cooling capacity of the whole machine and is not conducive to the stability and reliability of the whole machine.

### TECHNICAL PROBLEM

The main purpose of the present application is to propose an air conditioner and a vehicle, as well as a new air duct layout method and indoor and outdoor air intake methods, which can increase the cooling capacity of the whole machine and improve stability and reliability.

### TECHNICAL SOLUTION

In order to achieve the above purpose, the present application proposes an air conditioner, including:

a housing provided with an indoor air inlet, an indoor air outlet, an outdoor air inlet and an outdoor air outlet; an indoor air duct is formed in the housing to connect the indoor air inlet and the indoor air outlet, and an outdoor air duct is formed in the housing to connect the outdoor air inlet and the outdoor air outlet; the indoor air duct and the outdoor air duct are spaced apart from each other in a front-and-back direction; the indoor air inlet and the indoor air outlet are provided at a lower position of the housing, and the indoor air inlet and the indoor air outlet are provided in a front-and-back offset, so that the indoor air duct extends in the front-and-back direction and bends upward; the outdoor air inlet is provided at a side of the housing;
a first fan located in the indoor air duct; and
a second fan located in the outdoor air duct.

In an embodiment, the first fan is a cross-flow fan, and a rotation axis extends along a left-and-right direction; and
the second fan is an axial-flow fan, and a rotation axis extends along the front-and-back direction.

In an embodiment, the air conditioner includes an inner air duct cover provided in the housing and configured to form an upper side wall of the indoor air duct; a front end of the inner air duct cover is adjacent to a front inner wall surface of the housing, and a rear end of the inner air duct cover and the housing are jointly configured to form the outdoor air duct, so that the rear end of the inner air duct cover constitutes a front side wall of the outdoor air duct.

In an embodiment, the indoor air outlet is provided at a front side of the indoor air inlet;
an installation space is provided between two ends of the inner air duct cover in the left-and-right direction and the housing; and
the air conditioner further includes a compressor and an electric control box; the compressor and the electric control box are respectively provided in the installation spaces on left and right sides of the inner air duct cover.

In an embodiment, the indoor air outlet is provided at a front side of the indoor air inlet;
one side wall of the inner air duct cover along the left-and-right direction is adjacent to a corresponding wall surface of the housing, so that an installation space is provided between the other side wall and the corresponding wall surface of the housing; and
the air conditioner further includes a compressor and an electric control box, and the compressor and the electric control box are both provided in the installation space.

In an embodiment, the outdoor air inlet is provided at both opposite sides of the housing in the left-and-right direction; and
the rear end of the inner air duct cover is formed with air guide surfaces on two outer sides along the left-and-right direction; each of the air guide surfaces is provided adjacent to the outdoor air inlet, and the two air guide surfaces are provided gradually closer to each other in a direction of the second fan.

In an embodiment, the indoor air inlet is provided at a front side of the indoor air outlet;
one side wall of the inner air duct cover along the left-and-right direction is adjacent to a corresponding wall surface of the housing, so that an installation space is provided between the other side wall of the inner air duct cover and the corresponding wall surface of the housing; and
the air conditioner further includes a compressor and an electric control box, and the compressor and the electric control box are both located in the installation space.

In an embodiment, the front end of the inner air duct cover is formed with guide slopes along two opposite outer surfaces in the left-and-right direction, and the two guide slopes are gradually provided close to each other in a forward direction.

In an embodiment, the outdoor air inlet is provided at both opposite sides of the housing in the left-and-right direction; and
the outdoor air outlet is provided at a rear side of the housing.

In an embodiment, the housing is provided with an air inlet grille on one side along the left-and-right direction to form the outdoor air inlet; and/or
the air conditioner further includes an indoor heat exchanger and an outdoor heat exchanger; the outdoor heat exchanger is provided close to the outdoor air outlet, and the indoor heat exchanger is provided between the indoor air inlet and the indoor air outlet.

In an embodiment, the housing includes a top shell and a bottom shell buckled together in an up-and-down direction;
the air inlet grilles are provided at opposite sides of the top shell and the bottom shell along the left-and-right direction, and the air inlet grilles located on a same side jointly form the outdoor air inlet; and/or
a gap is provided at a joint between the top shell and the bottom shell at a rear side to form the outdoor air outlet.

In an embodiment, the air conditioner is configured to be installed on a car roof, and a lower end of the housing is configured to form a reserved gap with the car roof; a lower end surface of the housing is provided with a plurality of through holes connected to the outdoor air duct, and the plurality of through holes are configured to discharge water in the outdoor air duct or allow air passing through the reserved gap to enter the outdoor air duct from the plurality of through holes.

The present application also proposes a vehicle including the air conditioner, and the air conditioner at least includes:
a housing provided with an indoor air inlet, an indoor air outlet, an outdoor air inlet and an outdoor air outlet; an indoor air duct is formed in the housing to connect the indoor air inlet and the indoor air outlet, and an outdoor air duct is formed in the housing to connect the outdoor air inlet and the outdoor air outlet; the indoor air duct and the outdoor air duct are spaced apart from each other in a front-and-back direction; the indoor air inlet and the indoor air outlet are provided at a lower position of the housing, and the indoor air inlet and the indoor air outlet are provided in a front-and-back offset, so that the indoor air duct extends in the front-and-back direction and bends upward; the outdoor air inlet is provided at a side of the housing;
a first fan located in the indoor air duct; and
a second fan located in the outdoor air duct.

### BENEFICIAL EFFECT

In the technical solution of the present application, the indoor air duct and the outdoor air duct are provided in the front-and-back direction, ensuring a compact overall spatial layout. Due to the arrangement of the indoor air inlet and the indoor air outlet, the indoor air duct extends in the front-and-back direction and curves upward as a whole, that is, in an inverted U shape. The first fan realizes indoor air inlet and outlet circulation. The outdoor air duct inlets air from the side of the housing, and the air is supplied towards the rear of the whole machine, thereby combining the inverted U-shaped indoor air duct and the outdoor air duct that supplies air to the rear. The structural layout is compact, which facilitates the miniaturization design of the whole machine and reduces the driving resistance. Compared with the existing air conditioner layout, the present application can provide greater air volume in the same size space.

### BRIEF DESCRIPTION OF THE DRAWINGS

In order to more clearly illustrate the technical solutions in the embodiments of the present application or the related art, the following will briefly introduce the drawings that need to be used in the description of the embodiments or the related art. Obviously, the accompanying drawings in the following description are only some embodiments of the present application, and those skilled in the art can also obtain other drawings according to the structures shown in these drawings without creative effort.

FIG. 1 is a schematic perspective view of an air conditioner according to a first embodiment of the present application.

FIG. 2 is a schematic view of an outdoor air duct in FIG. 1.

FIG. 3 is a schematic cross-sectional view along A-A in FIG. 2.

FIG. 4 is a perspective exploded schematic view of the air conditioner according to a second embodiment of the present application.

FIG. 5 is a schematic view of the outdoor air duct in FIG. 4.

FIG. 6 is a schematic view of the air conditioner according to a third embodiment of the present application.

FIG. 7 is a schematic cross-sectional view along B-B in FIG. 6.

The realization, functional features and advantages of the present application will be further described in conjunction with the embodiments and with reference to the accompanying drawings.

### DETAILED DESCRIPTION OF THE EMBODIMENTS

The following will clearly and completely describe the technical solutions in the embodiments of the present application with reference to the accompanying drawings in the embodiments of the present application. Obviously, the described embodiments are only part of the embodiments of the present application, not all of them. Based on the embodiments in the present application, all other embodiments obtained by those skilled in the art without creative efforts fall within the protection scope of the present application.

It should be noted that if there are directional indications involved in the embodiments of the present application, the directional indications are only configured to explain the relative positional relationship, movement, etc. between the components in a specific posture. If the specific posture changes, the directional indication will also change accordingly.

In addition, if there are descriptions involving “first,” “second,” etc. in the embodiments of the present application, the descriptions of “first,” “second,” etc. are only for descriptive purposes, and cannot be understood as indicating or implying their relative importance or implicitly indicating the number of indicated technical features. Thus, the features defined as “first” and “second” may explicitly or implicitly include at least one of these features. In addition, the technical solutions of the various embodiments can be combined with each other, but it must be based on the realization of those skilled in the art. When the combination of technical solutions is contradictory or cannot be realized, it should be considered that the combination of technical solutions does not exist, nor within the protection scope required by the present application.

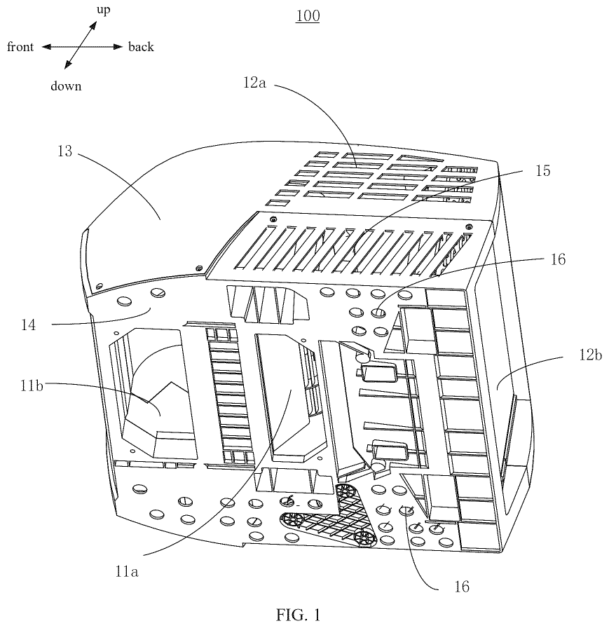

The present application provides an air conditioner and a vehicle that are designed to have a more compact layout and increase air intake volume. FIGS. 1 to 7 are embodiments of the air conditioner provided by the present application.

Referring to FIG. 1 to 3, the air conditioner 100 includes a housing 1, a first fan 2 and a second fan 3. The housing 1 is provided with an indoor air inlet 11a, an indoor air outlet 11b, an outdoor air inlet 12a and an outdoor air outlet 12b. The housing 1 is formed with an indoor air duct 11 communicating the indoor air inlet 11a and the indoor air outlet 11b, and an outdoor air duct 12 communicating the outdoor air inlet 12a and the outdoor air outlet 12b. The indoor air duct 11 and the outdoor air duct 12 are spaced apart from each other in the front-and-back direction. The indoor air inlet 11a and the indoor air outlet 11b are provided at a lower position of the housing 1, and the indoor air inlet 11a and the indoor air outlet 11b are offset in the front-and-back direction, so that the indoor air duct 11 extends in the front-and-back direction, and is bent upward. The outdoor air inlet 12a is provided at the side of the housing 1; the first fan 2 is provided in the indoor air duct 11, and the second fan 3 is provided in the outdoor air duct 12.

In the technical solution of the present application, the indoor air duct 11 and the outdoor air duct 12 are provided in the front-and-back direction, ensuring that the overall space layout is compact. Due to the arrangement of the indoor air inlet 11a and the indoor air outlet 11b, the indoor air duct 11 as a whole extends in the front-and-back direction and bends upward, that is, in an inverted U shape. The first fan 2 realizes indoor air inlet and outlet circulation, while the outdoor air duct 12 takes in air from the side of the housing 1 and faces the rear of the whole machine to take away air, thereby combining the inverted U-shaped indoor air duct 11 and the outdoor air duct 12 that supplies air to the rear. The structural layout is compact, which facilitates the miniaturization design of the whole machine and reduces the driving resistance. Compared with the existing air conditioner, the layout of the present application can provide greater air volume in the same size space.

It should be noted that the front-and-back direction, left-and-right direction, and up-and-down direction in the present application are all relative direction. The front-and-back direction is the length direction of the housing 1; the left-and-right direction is the width direction of the housing 1; and the up-and-down direction is the height direction of the housing 1. In the present application, the length direction of the housing 1 is consistent with the length direction of the vehicle, and the front side is the direction of the vehicle front.

It can be understood that the extension direction of the indoor air duct 11 and the outdoor air duct 12 is affected by the orientation of the first fan 2 and the second fan 3. In the present application, the indoor air duct 11 and the outdoor air duct 12 can be provided to be distributed in a straight line. In order to make the internal layout of the housing 1 more compact, the first fan 2 is a cross-flow fan with a rotation axis extending in the left-and-right direction, and the second fan 3 is an axial-flow fan with a rotation axis extending in the front-and-back direction. That is, the two are vertically distributed structures, and the indoor air inlet 11a can coincide with the orientation of the outdoor air inlet 12a, making the layout more compact.

Further, the air conditioner 100 includes an inner air duct cover 4 provided in the housing 1 and configured to form the upper side wall of the indoor air duct 11. The front end of the inner air duct cover 4 is adjacent to the front inner wall surface of the housing 1. The rear end of the air duct cover 4 and the housing 1 jointly define the outdoor air duct 12, so that the rear end of the inner air duct cover 4 constitutes the front side wall of the outdoor air duct 12. That is, the indoor air duct 11 is provided entirely on the front side of the housing 1, and the space reserved at the rear of the inner air duct cover 4 forms the outdoor air duct 12. The indoor air duct 11 adopts a layout that is offset to one side inside the whole machine, so that within the same size space, the surrounding space of the internal compressor layout is larger, which improves the compatibility of replacing different compressors for different cooling capacity requirements during the compressor design process.

Not only that, the bottom wall of the housing 1 is provided with an enclosure plate 17 protruding upward, and the enclosure plate 17 is snap-connected with the inner air duct cover 4 to jointly enclose and form the indoor air duct 11. The shape of the enclosure 17 is adapted to the inner air duct cover 4.

The present application does not limit the formation method of outdoor air inlet. The air inlet opening can be designed separately. Taking into account the impurities and rainwater that may accompany the air inlet, in an embodiment, the housing 1 is provided with an air inlet grille 15 along one side of the left-and-right direction, to form the outdoor air inlet 12a. The air inlet grille 15 can form a plurality of holes, which not only increases the overall size of the outdoor air inlet 12a, but also plays a protective role.

Furthermore, the air conditioner 100 also includes an indoor heat exchanger 8 and an outdoor heat exchanger 7. The outdoor heat exchanger 7 is located on the side of the second fan 3 away from the first fan 2 and is located close to the outdoor air outlet 12b. The indoor heat exchanger 8 is provided between the indoor air inlet 11a and the indoor air outlet 11b. The outdoor heat exchanger 7 is provided at the end of the outdoor air duct 12 in order to allow the outdoor air flowing in from all parties to be mixed in the outdoor air duct 12 and exchange heat through the outdoor heat exchanger 7 with a larger air volume, thereby improving the heat exchange efficiency. The installation position of the indoor heat exchanger 8 is affected by the design orientation of the indoor air outlet 11b and the indoor air inlet 11a. It should be noted that the outdoor heat exchanger 7 is a condenser and the indoor heat exchanger 8 is an evaporator.

It should be noted that the above two related technical features, the settings of the air inlet grille 15 and the heat exchanger, can be set simultaneously or alternatively. In the present application, they are set simultaneously.

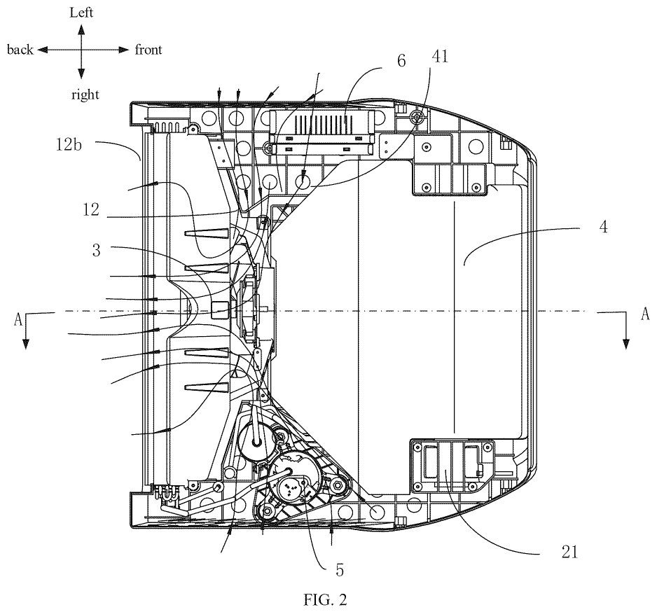

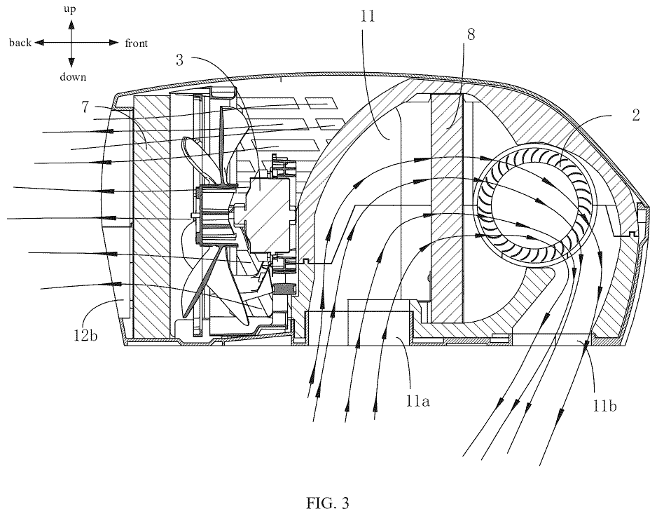

Please referring to FIGS. 2 to 3, in the first embodiment, the indoor air outlet 11b is located on the front side of the indoor air inlet 11a, and there are the installation spaces reserved between the left and right ends of the inner air duct cover 4 and the housing 1. The air conditioner 100 also includes a compressor 5 and an electric control box 6. The compressor 5 and the electric control box 6 are respectively located in the installation spaces on the left and right sides of the inner air duct cover 4. That is, the airflow in the indoor air duct 11 is transmitted from back to front, and the entire inner air duct cover 4 is in the middle and forward position relative to the housing 1. At this time, both left and right sides of the inner air duct cover 4 are reserved with the installation space, so the electric control box 6 and the compressor 5 are installed on the left and right opposite sides of the inner air duct cover 4. When the outdoor air inlet 12a is opened on the left and right opposite sides of the housing 1, the compressor 5 and the electric control box 6 can be provided at the air flow path of the outdoor air duct 12, so that heat can be dissipated when the outdoor air enters. At this time, a pipeline system can be set on the side of the outdoor air duct 12 close to the compressor 5. In an embodiment, the indoor air inlet 11a and the indoor air outlet 11b are both located on the central axis of the housing 1 along the front-and-back direction. At this time, the inner air duct cover 4 is centrally located.

Based on the above embodiment, the housing 1 is provided with outdoor air inlets 12a on opposite sides in the left-and-right direction, and the rear end of the inner air duct cover 4 is formed with air guide surfaces 41 on two outer sides in the left-and-right direction. Each air guide surface 41 is provided adjacent to the outdoor air inlet 12a, and the two air guide surfaces 41 are provided gradually approaching each other in the direction toward the second fan 2. The air guide surface 41 provides guidance for the air inlet from both sides of the housing 1, allowing outdoor air to enter the outdoor air duct 12 more smoothly. At the same time, the air guide surface 41, to a certain extent, also expands the size of the position of the outdoor air duct 12 corresponding to the outdoor air inlet 12a. That is, when air enters the two outdoor air inlets 12a, the corresponding reserved space of the housing 1 is larger, thereby increasing the air inlet volume and flowing in along the air guide surface 41.

Furthermore, the indoor heat exchanger 8 is located on the rear side of the first fan 2, that is, the indoor air is attracted by the first fan 2 and first contacts the indoor heat exchanger 8 for heat exchange, and then enters the indoor space along the indoor air duct 11. The outdoor heat exchanger 7 is provided at the rear of the second fan 3 so that the air introduced from all direction by the outdoor air duct 12 is mixed in the channel and then discharged after heat exchange through the outdoor heat exchanger 7.

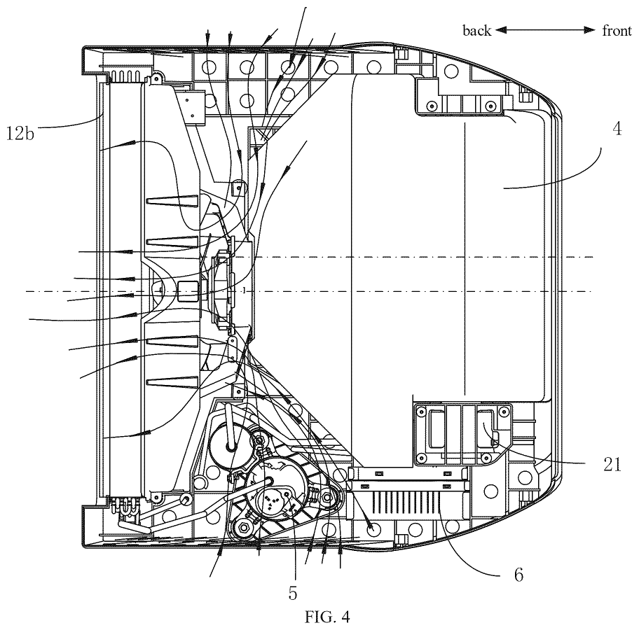

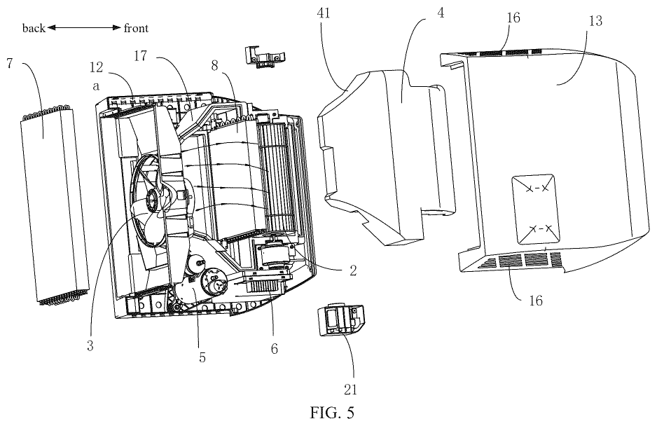

Please referring to FIGS. 4 to 5, in the second embodiment, the indoor air outlet 11b is located on the front side of the indoor air inlet 11a; one side wall of the inner air duct cover 4 along the left-and-right direction is adjacent to the corresponding wall of the housing 1, so as to reserve an installation space between the other side wall and the corresponding wall surface of the housing 1; the air conditioner 100 also includes a compressor 5 and an electric control box 6. The compressor 5 and the electric control box 6 are both located in the installation space. At this time, the airflow direction in the indoor air duct 11 is still from back to front, so the air inlet side of the indoor heat exchanger 8 and the placement direction of the first fan 2 are limited. The indoor air inlet 11a and the indoor air outlet 11b are both located at the side of the central axis of the housing 1 along the front-and-back direction, so that there is an installation space reserved between a side wall of the inner air duct cover 4 along the left-and-right direction and the inner wall of the housing 1. The motor cover 21 of the first fan 2 is also in the reserved installation space. At this time, the installation space formed by the inner air duct cover 4 on one side is larger. The electric control box 6 and the compressor 5 can be placed in the installation space, and the electric control box 6 is located on the front side of the housing 1 and is provided side by side with the inner air duct cover 4, so that when the air enters the outdoor air duct 12 from the side, the electric control box 6 can be prevented from blocking the outdoor air inlet, so that the air intake of the outdoor air duct 12 is smoother, and the larger space on one side is conducive to the layout of the pipeline system. There is enough space to install the pipeline fixed structure, and at the same time, it can ensure that there is more safety distance when the pipeline shakes and does not collide with the related components of the indoor air duct 11, thereby improving the safety of the pipeline system and the reliability of the entire machine.

It can be understood that this structural layout offset to one side of the whole machine has the advantage of easy electrical control wiring, because the motor cover 21 of the first fan 2 in the indoor air duct 11 is located in the inner position next to the electric control box 6. The compressor 5 is also provided at the same side as the electric control box 6 and close to the rear of the whole machine. The second fan 3 is provided at the central axis in the middle of the whole machine from the compressor 5. They all require electric control box 6 to dominate and control, so they are concentrated on the same side of the whole machine, which shortens the control circuit layout of the whole machine, simplifies the path of the control circuit in manufacturing, and improves the wiring efficiency. Similarly, because the wires are shortened, the cost of the electric control box 6 of the whole machine is reduced.

Based on the above embodiments, when the outdoor air inlets 12a are provided at both opposite sides of the housing 1 along the left-and-right direction, and the rear end of the inner air duct cover 4 is formed with air guide surfaces 41 on the two opposite outer sides along the left-and-right direction, due to the offset setting of the inner air duct cover 4, the distance between the air guide surface 41 corresponding to the compressor 5 and the compressor 5 increases compared with the first embodiment, increasing the outdoor air inlet volume and easing the problem of obstructing partial air inlet by the compressor 5, which enables better air inlet regulation as a whole, facilitates the circulating air inlet of the entire outdoor air inlet system, and improves the heat exchange efficiency of outdoor circulating air.

It can be understood that, in this embodiment, the installation orientations of the indoor heat exchanger 8 and the outdoor heat exchanger 7 are consistent with the first embodiment, that is, the indoor heat exchanger 8 is located on the rear side of the first fan 2, that is, the indoor air is under the suction of the first fan 2, it first contacts the indoor heat exchanger 8 for heat exchange and then enters the indoor space along the indoor air duct 11. The outdoor heat exchanger 7 is located at the rear of the second fan 3, so that the air introduced by the outdoor air duct 12 in the direction is mixed in the channel and then discharged after exchanging heat through the outdoor heat exchanger 7.

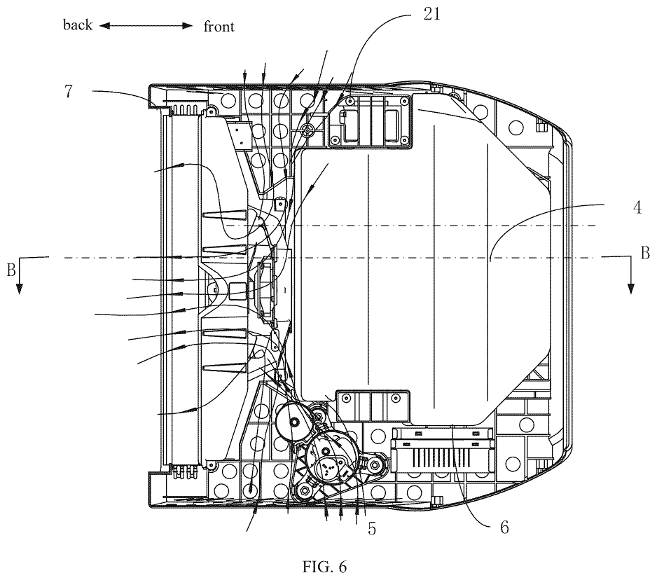

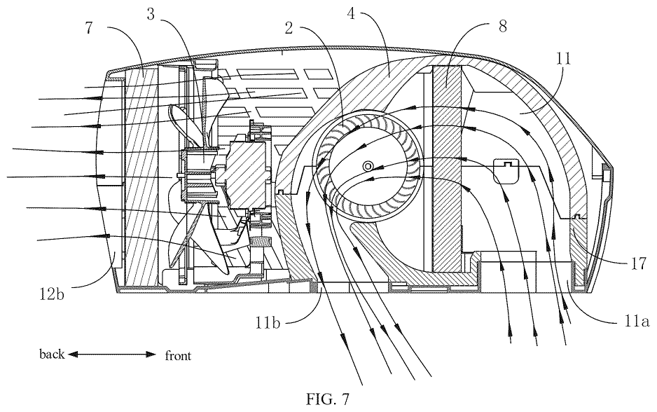

Please referring to FIGS. 6 to 7, in the third embodiment, the indoor air inlet 11a is located on the front side of the indoor air outlet 11b; one side wall of the inner air duct cover 4 along the left-and-right direction is adjacent to the corresponding wall of the housing 1, so as to reserve an installation space between the other side wall and the corresponding wall surface of the housing 1; the air conditioner 100 also includes a compressor 5 and an electric control box 6. The compressor 5 and the electric control box 6 are both located in the installation space. At this time, the air flow direction in the indoor air duct 11 is from front to back, and the indoor air direction is opposite to that in the second embodiment. Therefore, the placement orientation of the air inlet side of the indoor heat exchanger 8 and the first fan 2 is changed accordingly. The indoor air inlet 11a and the indoor air outlet 11b are both located on the side of the central axis of the housing 1 in the front-and-back direction, so that there is an installation space reserved between a side wall of the inner air duct cover 4 in the left-and-right direction and the inner wall of the housing 1. The motor cover 21 of the first fan 2 is located at the other side opposite to the reserved installation space due to the change in design orientation, adjacent to the housing 1. At this time, the installation space formed on one side of the inner air duct cover 4 has a larger space volume, and the electric control box 6 and the compressor 5 can be placed in the installation space. However, due to the changes in the installation orientation of the first fan 2 and the inner air duct cover 4, they are limited by the internal air duct structure and the placement of the first fan 2, it is not suitable to design the air guide surface 41 in this embodiment.

It can be understood that the motor cover 21 is on the left side at this time, and the compressor 5 and the electric control box 6 are on the right side. That is, the compressor 5 and the electric control box 6 do not need to be installed separately from the motor cover 21 at this time, but the size required for wiring is slightly longer than that of the second embodiment.

Furthermore, since the installation direction of the inner air duct cover 4 is changed, the front end of the inner air duct cover 4 is formed with guide slopes along two opposite outer sides in the left-and-right direction, and the two guide slopes are provided gradually closer to each other in the forward direction. The structure of the front end can be improved to make the front end tapered. At this time, the shape of the front of the whole machine can be improved, and the size of the front end of the whole machine can be made smaller, further reducing the air resistance of the whole machine in appearance.

Existing axial-flow fans generally discharge air from the upper part. In this way, foreign matter can easily enter the air duct from the top of the whole machine, causing dirt and blockage of the air duct. Moreover, the upper air outlet is affected by the low air pressure against the wall when the vehicle is moving forward, and affects the air outlet. The internal air outlet causes squeezing and affects the upward air outlet, which affects the heat exchange air circulation of the condenser. For this reason, in an embodiment, the housing 1 is provided with outdoor air inlets 12a on both opposite sides of the housing 1 in the left-and-right direction, and outdoor air outlets 12b are provided at the rear side of the housing 1. At this time, the external air enters from both sides of the housing 1 and always flows backward, which avoids the retracement of the air flow. The air inlet volume from both sides is larger, which increases the external air inlet volume and ensures the flow direction of the air inlet. It solves the problem that foreign objects are easy to fall into the upper air outlet and affect the air outlet, and the upper air outlet is affected by the low air pressure against the wall during fast driving of the vehicle and the air outlet is compressed inward, affecting the upward air outlet and causing poor heat exchange.

It can be understood that the housing 1 can be an integrally formed part or an assembly. In an embodiment, the housing 1 includes a top shell 13 and a bottom shell 14 that are provided to snap together relative to each other in the up and down direction. Correspondingly, the air inlet grilles 15 can be provided at the opposite sides of the top shell 13 and the bottom shell 14 along the left-and-right direction. The air inlet grilles 15 located on the same side jointly form an outdoor air inlet 12a, or the air inlet grille 15 can only be provided at the top shell 13 or the bottom shell 14. It is obvious that the air inlet grille 15 is designed on the top shell 13 and the bottom shell 14 at the same time for a larger air intake volume. At the same time, there is a notch provided at the joint between the top shell 13 and the bottom shell 14 at the rear side to form the outdoor air outlet 12b. It is also possible to provide only one through hole on the top shell 13 or the bottom shell 14 as the outdoor air inlet 12a.

It should be noted that the above two related technical features, when the housing 1 is designed in a split design, the outdoor air inlet 12a and the outdoor air outlet 12b can be formed either one of them or at the same time. In the present application, they are set at the same time.

Not only that, the air conditioner 100 is configured to be installed on the roof of the car, and the lower end of the housing 1 is configured to form a reserved gap with the roof. The lower end of the housing 1 is provided with a plurality of through holes 16 that communicate with the outdoor air duct 12. The plurality of through holes 16 are configured to discharge water in the outdoor air duct 12 or to allow the air passing through the reserved gaps to enter the outdoor air duct 12 from the plurality of through holes 16. The plurality of through holes 16 not only have a drainage function to ensure that water entering the interior of the machine in rainy weather can be quickly drained away from the through holes 16, but also serve as air inlets to allow outdoor air to enter the outdoor air duct 12 from the side and bottom of the housing 1 to increase the air intake volume.

Further, the diameter of each through hole 16 is not less than 20 mm.

The present application also provides a vehicle, including the above-mentioned air conditioner 100. The vehicle includes all the technical features of the above-mentioned air conditioner 100. Therefore, it also has the technical effects brought by all the above-mentioned technical features, which will not be described again here.

Specifically, the present application does not limit the specific type of vehicle. Taking the RV as an example, the RV requires a larger air intake volume due to its structural characteristics to improve its heat exchange efficiency. The air conditioner is a top-mounted mechanism, and located on the top of the vehicle body. The air conditioner does not fit closely with the top of the car body, but a certain gap is reserved. The indoor air duct 11 presents an inverted U-shaped cross-flow air duct, and the indoor air duct 11 is located close to the rear or front of the whole machine. The indoor air outlet 11b and the indoor air inlet 11a are both provided at the bottom wall of the housing 1 and are communicated with the indoor environment of the vehicle to achieve indoor air inlet and outlet circulation. At the same time, the outdoor air duct 12 of the whole machine is an axial-flow air duct system, and the axial-flow air duct is provided vertically to supply air to the rear of the whole machine. The outdoor air inlet 12a of the outdoor air duct 12 is located on both sides of the rear of the bottom shell 14 and the top shell 13 of the housing 1, and also includes multiple circular through holes 16 provided at intervals at the bottom of the bottom shell 14. These through holes 6 also have the drainage function of the bottom shell 14 to ensure that water entering the inside of the machine can be drained quickly in rainy weather. The outdoor air outlet 12b is a square opening formed by the bottom shell 14 and the top shell 13 being enclosed in half from top to bottom, and is provided towards the rear of the whole machine. The indoor air duct 11 is offset inside the housing 1. This offset layout structure includes the motor cover 21, compressor 5 and electric control box 6 of the cross-flow motor concentrated in the reserved installation space, thus increasing the air inlet area of the outdoor air duct 12, improving the smoothness of the air inlet of the outdoor air duct 12, and improving the air inlet and heat exchange efficiency when the outdoor air duct 12 of the whole machine adopts an axial-flow air duct system.

The above are only some embodiments of the present application, and do not limit the patent scope of the present application. Under the inventive concept of the present application, the equivalent structural transformations made by using the description of the present application and the contents of the accompanying drawings, or directly/indirectly used in other relevant technical fields, are all included in the protection scope of the present application.

1.-13. (canceled)

14. An air conditioner comprising:
a housing including:
an indoor air inlet and an indoor air outlet at a lower position of the housing and provided in a front-and-back offset;
an outdoor air inlet at a side of the housing; and
an outdoor air outlet;
an indoor air duct in the housing and connected between the indoor air inlet and the indoor air outlet, the indoor air duct extending in a front-and-back direction and bending upward;
an outdoor air duct in the housing and connected between the outdoor air inlet and the outdoor air outlet, the outdoor air duct being spaced apart from the indoor air duct in the front-and-back direction;
a first fan located in the indoor air duct; and
a second fan located in the outdoor air duct.

15. The air conditioner according to claim 14, wherein:
the first fan is a cross-flow fan with a rotation axis extending along a left-and-right direction; and
the second fan is an axial-flow fan with a rotation axis extending along the front-and-back direction.

16. The air conditioner according to claim 14, further comprising:
an inner air duct cover in the housing and configured to form an upper side wall of the indoor air duct;
wherein a front end of the inner air duct cover is adjacent to a front inner wall surface of the housing, and a rear end of the inner air duct cover and the housing are jointly configured to form the outdoor air duct, with the rear end of the inner air duct cover constituting a front side wall of the outdoor air duct.

17. The air conditioner according to claim 16, wherein the indoor air outlet is provided at a front side of the indoor air inlet.

18. The air conditioner according to claim 17, further comprising:
a compressor in a first installation space on between the housing and a first end of the inner air duct cover in a left-and-right direction; and
an electric control box in a installation space between the housing and a second end of the inner air duct cover in the left-and-right direction, the second end being opposite to the first end.

19. The air conditioner according to claim 17, further comprising:
a compressor and an electric control box, both in an installation space between one side wall of the inner air duct cover along a left-and-right direction and a corresponding wall surface of the housing.

20. The air conditioner according to claim 17, wherein:
the outdoor air inlet is one of two outdoor air inlets provided at two opposite sides of the housing in a left-and-right direction, respectively; and
the rear end of the inner air duct cover is formed with air guide surfaces on two outer sides along the left-and-right direction, each of the air guide surfaces being adjacent to one of the two outdoor air inlets, and the two air guide surfaces being provided gradually closer to each other in a direction toward the second fan.

21. The air conditioner according to claim 16, wherein the indoor air inlet is provided at a front side of the indoor air outlet.

22. The air conditioner according to claim 21, further comprising:
a compressor and an electric control box, both located in an installation space between one side wall of the inner air duct cover along a left-and-right direction and a corresponding wall surface of the housing.

23. The air conditioner according to claim 21, wherein the front end of the inner air duct cover is formed with guide slopes along two opposite outer surfaces in a left-and-right direction, respectively, and the two guide slopes are gradually provided close to each other in a forward direction.

24. The air conditioner according to claim 14, wherein:
the outdoor air inlet is one of two outdoor air inlets provided at two opposite sides of the housing in a left-and-right direction; and
the outdoor air outlet is provided at a rear side of the housing.

25. The air conditioner according to claim 14, wherein the outdoor air inlet includes an air inlet grille on one side of the housing along a left-and-right direction.

26. The air conditioner according to claim 14, further comprising:
an indoor heat exchanger provided between the indoor air inlet and the indoor air outlet; and
an outdoor heat exchanger provided close to the outdoor air outlet.

27. The air conditioner according to claim 14, wherein the housing includes a top shell and a bottom shell buckled together in an up-and-down direction.

28. The air conditioner according to claim 27, wherein:
the outdoor air inlet is one of two outdoor air inlets provided on two opposite sides of the housing in a left-and-right direction; and
each of the two outdoor air inlets is jointly formed by air inlet grilles provided at one of opposite sides of the top shell and the bottom shell along the left-and-right direction.

29. The air conditioner according to claim 27, wherein, a gap is provided at a joint between the top shell and the bottom shell at a rear side to form the outdoor air outlet.

30. The air conditioner according to claim 14, wherein:
the air conditioner is configured to be installed on a car roof, and a lower end of the housing is configured to form a reserved gap with the car roof;
a lower end surface of the housing is provided with a plurality of through holes connected to the outdoor air duct and configured to discharge water in the outdoor air duct or allow air passing through the reserved gap to enter the outdoor air duct through the plurality of through holes.

31. A vehicle comprising:
a vehicle body; and
an air conditioner including:
a housing including:
an indoor air inlet and an indoor air outlet at a lower position of the housing and provided in a front-and-back offset;
an outdoor air inlet at a side of the housing; and
an outdoor air outlet;
an indoor air duct in the housing and connected between the indoor air inlet and the indoor air outlet, the indoor air duct extending in a front-and-back direction and bending upward;
an outdoor air duct in the housing and connected between the outdoor air inlet and the outdoor air outlet, the outdoor air duct being spaced apart from the indoor air duct in the front-and-back direction;
a first fan located in the indoor air duct; and
a second fan located in the outdoor air duct.

32. The vehicle according to claim 31, wherein:
the first fan is a cross-flow fan with a rotation axis extending along a left-and-right direction; and
the second fan is an axial-flow fan with a rotation axis extending along the front-and-back direction.

33. The vehicle according to claim 31, wherein:
air conditioner further includes an inner air duct cover in the housing and configured to form an upper side wall of the indoor air duct; and
a front end of the inner air duct cover is adjacent to a front inner wall surface of the housing, and a rear end of the inner air duct cover and the housing are jointly configured to form the outdoor air duct, with the rear end of the inner air duct cover constituting a front side wall of the outdoor air duct.
